(19) United States
(12) Patent Application Publication
(10) Pub. No.: US 2024/0215644 A1
(43) Pub. Date: Jul. 4, 2024

(54) METHOD OF GENERATING AEROSOL AND ELECTRONIC DEVICE FOR PERFORMING THE METHOD

(71) Applicant: KT&G CORPORATION, Daejeon (KR)

(72) Inventors: In Su PARK, Daejeon (KR); Dae Ho KIM, Gimhae-si (KR)

(73) Assignee: KT&G CORPORATION, Daejeon (KR)

(21) Appl. No.: 17/927,157

(22) PCT Filed: Jun. 28, 2022
(86) PCT No.: PCT/KR2022/009166

§ 371 Date: Nov. 22, 2022

(30) Foreign Application Priority Data
Sep. 16, 2021 (KR) 10-2021-0124315

(51) Int. Cl. A24F 40/465; A24F 40/20; A24F 40/51; A24F 40/53; A24F 40/57

(52) U.S. Cl. CPC A24F 40/465; A24F 40/20; A24F 40/51; A24F 40/53; A24F 40/57

(57) ABSTRACT

To generate an aerosol, a microwave of a preset frequency may be generated using a generator, the generated microwave may be supplied to a resonator formed based on a waveguide through a microwave coupler, an electromagnetic field may be generated by resonating the microwave using the resonator, and an aerosol may be generated when the electromagnetic field heats an aerosol-generating substrate inserted into the waveguide.

### TECHNICAL FIELD

The following example embodiments relate to a technology of generating an aerosol, and more specifically, to a technology of generating an aerosol using microwaves.

### BACKGROUND ART

Recently, demands for alternative ways to overcome disadvantages of general cigarettes have increased. For example, the demand for a method of generating an aerosol by heating an aerosol-generating substrate included in a cigarette rather than by burning the cigarette is increasing. Accordingly, research on a heating-type cigarette or a heating-type aerosol generator has been actively conducted.

Microwave heating technology is used to directly heat polar molecules such as water or organic solvents based on the principle of dielectric heating, and has a high energy efficiency and high heating rate because selectively heating only a material required for heating using microwaves is possible. However, since electrical energy supplied with an efficiency of about 60% to 70% is converted into microwave energy in a process of generating microwaves, higher energy efficiency may be ensured only when the heat capacity required to heat a material using microwaves is less than or equal to 50% of a heat capacity required in an existing external heating scheme. In addition, in a microwave heating scheme, the heating rate may increase as the heat capacity decreases, in comparison to the existing external heating scheme.

Until now, the microwave heating scheme has been mostly applied to fields requiring a large-scale heating capability. Devices supplied to microwave technology-related industries such as essential parts including microwave generators such as magnetrons are available for large capacities greater than the kilowatt (KW) level, and even a household microwave oven has a microwave output of about 900 watts (W).

From a physical perspective, as the size and amount of a heating material decrease, the effect of the microwave heating scheme that is a direct heating scheme may be maximized in comparison to the external heating scheme, and the heating rate may also significantly increase. However, since a wavelength of a microwave used for heating is about 12 centimeters (cm) or about 30 cm, there is a demand for technology of precisely designing a microwave device to miniaturize a heating device.

### DISCLOSURE OF THE INVENTION

### Technical Goals

Recently, with the development of communication-related technologies, technologies of microwave devices used for communication are also rapidly developing. In particular, a solid-state-based microwave generator used only for communication has been advanced enough to gradually replace a magnetron, which is a high-power microwave generator that was previously impossible to replace, in some technical fields. If such a solid-state microwave device, a miniaturized microwave transmission line, and the like are used, a compact microwave heating device may be implemented.

An example embodiment may provide a method of generating an aerosol, performed by an electronic device.

An example embodiment may provide an electronic device that may generate an aerosol.

### Technical Solutions

According to an example embodiment, an electronic device includes a controller configured to control an operation of the electronic device, a generator configured to generate a microwave of a preset frequency, a microwave coupler configured to supply the generated microwave to a resonator, the resonator configured to generate an amplified electromagnetic field by resonating the microwave, and an insertion into which an aerosol-generating substrate is inserted such that the aerosol-generating substrate is adjacent to the resonator, wherein an aerosol is generated when at least a portion of the electromagnetic field heats the aerosol-generating substrate.

The resonator may be formed by a cavity between an outer conductor and a central conductor which each have a cylindrical shape.

The outer conductor and the central conductor may have the same axis. The insertion may be formed based on an inner region of the central conductor.

A length of the resonator may be ¼ of a wavelength of the microwave in the resonator. A first end of the resonator may be formed as a short-circuited end in which the outer conductor and the central conductor are connected, and a second end of the resonator facing the first end may be formed as an open end in which the outer conductor and the central conductor are not connected and are spaced apart from each other.

The outer conductor and the central conductor may form a waveguide. The central conductor may be connected to a first end of the waveguide. The aerosol-generating substrate may be inserted through the insertion to be adjacent to an open end of the central conductor disposed opposite the first end.

The resonator may be formed by the first end of the waveguide and the central conductor.

According to an example embodiment, a method of generating an aerosol, performed by an electronic device, includes generating a microwave of a preset frequency using a generator, supplying the generated microwave to a resonator through a microwave coupler, the resonator being formed by a cavity between an outer conductor and a central conductor which each have a cylindrical shape, generating an amplified electromagnetic field by resonating the microwave using the resonator, and generating an aerosol when at least a portion of the electromagnetic field heats an aerosol-generating substrate inserted to be adjacent to the central conductor.

The outer conductor and the central conductor may have the same axis.

The generating of the amplified electromagnetic field by resonating the microwave using the resonator may include resonating the microwave by forming a pattern of the microwave in a transvers electromagnetic (TEM) mode by a structure of the outer conductor and the central conductor.

A length of the resonator may be ¼ of a wavelength of the microwave in the resonator. A first end of the resonator may be formed as a short-circuited end in which the outer conductor and the central conductor are connected, and a second end of the resonator facing the first end may be formed as an open end in which the outer conductor and the central conductor are not connected and are spaced apart from each other.

A length between the first end and the second end may be an integer multiple of ¼ of the wavelength.

The outer conductor and the central conductor may form a waveguide. The central conductor may be connected to a first end of the waveguide. The aerosol-generating substrate may be inserted to be adjacent to an open end of the central conductor disposed opposite the first end.

The resonator may be formed by the first end of the waveguide and the central conductor.

A diameter of an insertion connected to an inner space of the central conductor may be less than ½ of a wavelength of the microwave.

A dielectric may be included in the cavity.

The method may further include measuring a temperature of the aerosol-generating substrate, and stopping the generating of the microwave when the measured temperature is greater than or equal to a preset first threshold temperature.

The generating of the microwave of the preset frequency using the generator may include generating the microwave when the temperature of the aerosol-generating substrate measured in a state in which the generating of the microwave is stopped is less than a preset second threshold temperature.

### Effects

A method of generating an aerosol, performed by an electronic device, may be provided.

An electronic device for generating an aerosol may be provided.

### BRIEF DESCRIPTION OF DRAWINGS

FIG. 1 illustrates an electronic device according to an example embodiment.

FIG. 2 is a diagram illustrating a configuration of an electronic device according to an example embodiment.

FIG. 3 is a diagram illustrating a configuration of a controller according to an example embodiment.

FIG. 4 is a diagram illustrating a configuration of a resonator formed based on a waveguide according to an example embodiment.

FIG. 5 illustrates an electric field formed by microwaves according to an example embodiment.

FIG. 6 illustrates a sensor according to an example embodiment.

FIGS. 7 and 8 illustrate examples of a structure of a cigarette according to an example embodiment.

FIG. 9 is a flowchart of a method of generating an aerosol according to an example embodiment.

FIG. 10 is a flowchart of a method of controlling a generation of a microwave based on a temperature of an aerosol-generating substrate according to an example embodiment.

### BEST MODE FOR CARRYING OUT THE INVENTION

The following detailed structural or functional description is provided as an example only and various alterations and modifications may be made to example embodiments. Here, example embodiments are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/including” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments will be described in detail with reference to the accompanying drawings. When describing the example embodiments with reference to the accompanying drawings, like reference numerals refer to like elements and any repeated description related thereto will be omitted.

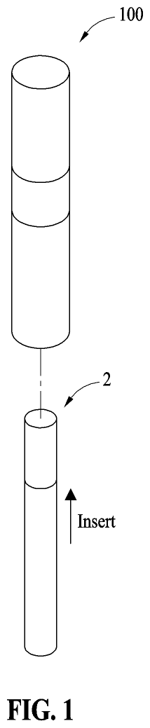

FIG. 1 illustrates an electronic device according to an example embodiment.

Referring to FIG. 1, an electronic device 100 may generate an aerosol by heating an aerosol-generating substrate in a cigarette 2 inserted into the electronic device 100. A user may be able to inhale the generated aerosol to smoke. For example, the electronic device 100 may employ a scheme of heating an aerosol-generating substrate using an electromagnetic field generated by resonating microwaves, such as a microwave oven, instead of a scheme of applying heat directly to the aerosol-generating substrate. The above scheme may be called “microwave induction heating.”

To heat the aerosol-generating substrate, a cavity resonator for forming high-density microwaves may be required. A scheme of transmitting a microwave generated through a source such as a generator and supplying the microwave to a medium may enable only slight heating, and an energy efficiency may be extremely low.

Since a wavelength of a microwave of 2.45 gigahertz (GHz), which is an industrial scientific and medical equipment (ISM) frequency allowed for heating, is about 120 millimeters (mm), a size of a cavity resonator having a shape of a square box or a cylinder may need to be about 60 mm or greater. Microwaves may not enter a resonator having a size smaller than 60 mm and the above shape.

In an example, to fabricate a resonator with a size less than a limit size of a resonator according to a constraint generated by a size of a wavelength, a pattern of an electromagnetic field may be formed in a transverse electromagnetic (TEM) mode by implementing the resonator in the form of a coaxial or parallel plate so that a structure in which there is no cutoff frequency of an electromagnetic field may be formed. In another example, a method of using a microwave of an extremely high frequency or filling a resonator with a material having an extremely high dielectric constant may be used.

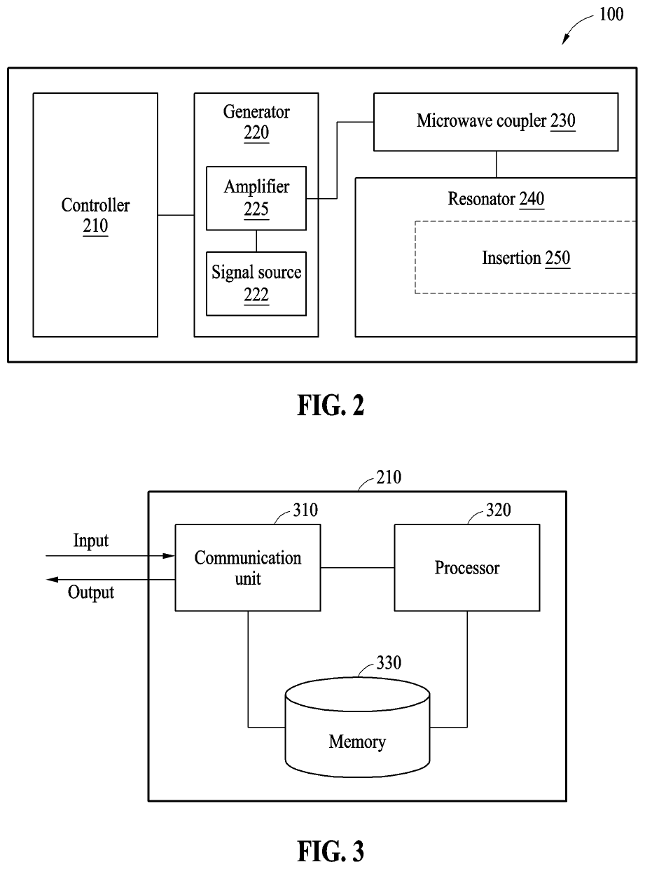

According to an example embodiment, a resonator may be typically in a form of a waveguide having a predetermined length, and both ends of the waveguide may be formed as a short-circuited end (impedance=0) or an open end (impedance=∞). A quarter wavelength resonator may have a shortest length among available resonators, a first end of the quarter wavelength resonator may be shorted by forming a metal wall and a second end thereof may be opened such that a metal portion may be absent. A method of generating an aerosol using a quarter wavelength resonator will be described in detail below with reference to FIGS. 2 through 10.

According to an example embodiment, the cigarette 2 may be inserted such that coaxial resonators surround at least a portion (e.g., an aerosol-generating substrate) of the cigarette 2, and the aerosol-generating substrate may be heated by an electromagnetic field generated by the resonator. For example, the cigarette 2 may be divided into a first portion including the aerosol-generating substrate and a second portion including a filter or the like. Alternatively, the second portion of the cigarette 2 may also include the aerosol-generating substrate.

The first portion may be entirely inserted into the electronic device 100, and the second portion may be exposed outside. Alternatively, the first portion may be only partially inserted into the electronic device 100, and the first portion may be entirely inserted and the second portion may be partially inserted into the electronic device 100. The user may inhale the aerosol with the second portion in a mouth of the user. In this case, an aerosol may be generated as external air passes through the first portion, and the generated aerosol may pass through the second portion into the mouth of the user.

FIG. 2 is a diagram illustrating a configuration of an electronic device according to an example embodiment.

According to an example embodiment, the electronic device 100 may include a controller 210, a generator 220, a microwave coupler 230, a resonator 240, and an insertion 250. The generator 220 may include a signal source 222, such as an oscillator, and an amplifier 225. Although not shown in the drawings, the electronic device 100 may further include general-purpose components. For example, the electronic device 100 may include a display (or an indicator) for outputting visual information and/or a motor for outputting tactile information. In addition, the electronic device 100 may further include at least one sensor (e.g., a puff detection sensor, a temperature detection sensor, a cigarette insertion detection sensor, etc.). The electronic device 100 may be manufactured to have a structure that allows external air to be introduced or internal gas to be discharged even in a state in which the cigarette 2 is inserted.

The external air may be introduced through at least one air passage formed in the electronic device 100. For example, opening or closing of the air passage formed in the electronic device 100 and/or a size of the air passage may be adjusted by a user. Accordingly, an amount of smoke, a smoking impression, and the like may be adjusted by the user. In another example, the external air may be introduced into the cigarette 2 through at least one hole formed in a surface of the cigarette 2.

According to an example embodiment, although not shown in the drawings, the electronic device 100 may also form a system along with a separate cradle. For example, the cradle may be used to charge a battery of the electronic device 100.

The controller 210 may control operations of the electronic device 100. The controller 210 will be described in detail below with reference to FIG. 3.

The signal source 222 of the generator 220 may generate a microwave of a preset frequency based on a control signal of the controller 210. The preset frequency may be a frequency within an ISM frequency band. The preset frequency may be, for example, 2.45 GHz or 5.8 GHz, but is not limited thereto.

The amplifier 225 may amplify an output of the microwave generated by the signal source 222 to an output sufficiently strong to be used for heating a material. The amplifier 225 may adjust an output, which is to be output from the amplifier 225, by adjusting an intensity of the signal source 222 based on a signal of the controller 210. For example, an amplitude of the microwave may be reduced or increased. By adjusting the amplitude of the microwave, power of the microwave may be adjusted.

The microwave coupler 230 may supply a microwave to the resonator 240. Allowing the microwave generated by the generator 220 to supply from a microwave transmission line (or a waveguide) into the resonator may be called “resonator coupling,” and such a structure may be defined as the microwave coupler 230.

The resonator 240 may form an amplified electromagnetic field by resonating the supplied microwave. At least a portion of the electromagnetic field formed by the resonating microwave may generate an aerosol by heating the aerosol-generating substrate inserted into a waveguide.

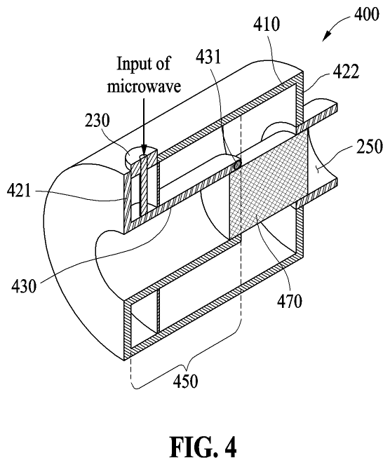

According to an example embodiment, the resonator 240 may be a quarter wavelength resonator, a first end of the resonator 240 may be short-circuited through a metal wall, and a second end of the resonator 240 may be opened. A structure of the resonator 240 according to an example embodiment will be described in detail with reference to FIG. 4 below.

The insertion 250 may be formed based on the waveguide. For example, the waveguide may include a central conductor and an outer conductor. The resonator 240 may be formed in an inner region of the waveguide, and the insertion 250 may be formed in an inner region of the central conductor.

FIG. 3 is a diagram illustrating a configuration of a controller according to an example embodiment.

According to an example embodiment, the controller 210 may include a communication unit 310, a processor 320, and a memory 330.

The communication unit 310 may be connected to the processor 320 and the memory 330 to transmit and receive data to and from the processor 320 and the memory 330. The communication unit 310 may be connected to another external device and transmit and receive data to and from the external device. Hereinafter, transmitting and receiving “A” may refer to transmitting and receiving “information or data indicating A.”

The communication unit 310 may be implemented as a circuitry in the controller 210. For example, the communication unit 310 may include an internal bus and an external bus. In another example, the communication unit 310 may be an element that connects the controller 210 and the external device. The communication unit 310 may be an interface. The communication unit 310 may receive data from the external device and transmit the data to the processor 320 and the memory 330.

The processor 320 may process the data received by the communication unit 310 and data stored in the memory 330. A “processor” described herein may be a hardware-implemented data processing device having a physically structured circuit to execute desired operations. The desired operations may include, for example, code or instructions included in a program. The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 320 may execute computer-readable code (e.g., software) stored in a memory (e.g., the memory 330) and instructions triggered by the processor 320.

The memory 330 may store the data received by the communication unit 310 and data processed by the processor 320. For example, the memory 330 may store the program (or an application, or software). The program to be stored may be a set of syntaxes that are coded and executable by the processor 320 to control the electronic device 100.

According to an aspect, the memory 330 may include, for example, at least one volatile memory, non-volatile memory, random-access memory (RAM), flash memory, a hard disk drive, and an optical disc drive.

The memory 330 may store an instruction set (e.g., software) for operating the controller 210. The instruction set for operating the controller 210 may be executed by the processor 320.

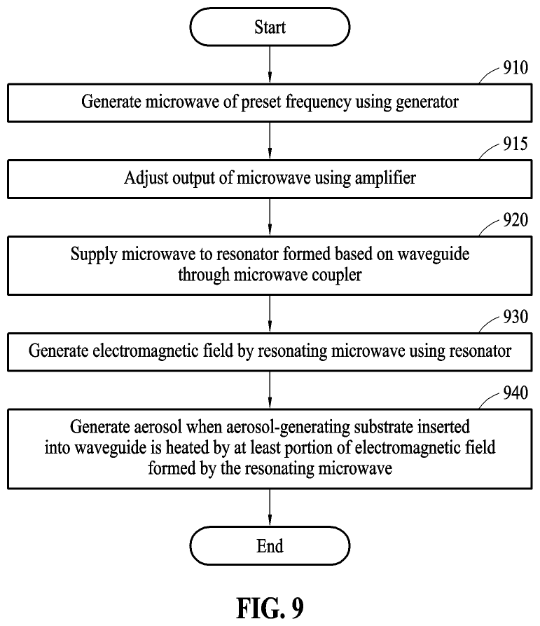

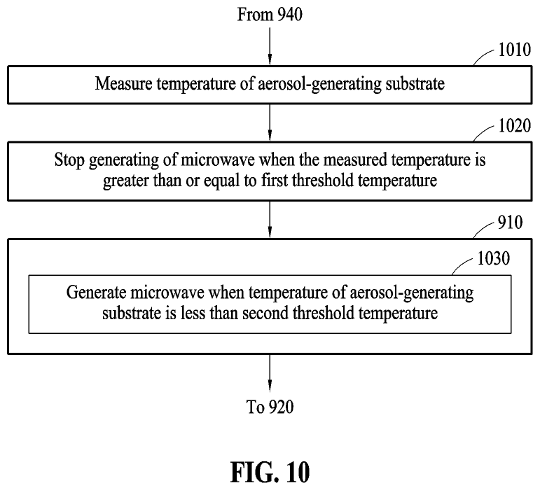

The communication unit 310, the processor 320, and the memory 330 will be described in detail with reference to FIGS. 9 and 10 below.

FIG. 4 is a diagram illustrating a configuration of a resonator formed based on a waveguide according to an example embodiment.

According to an example embodiment, a resonator 450 may be formed based on a waveguide 400 that includes walls 421 and 422, an outer conductor 410, and a central conductor 430. The resonator 450 may correspond to the resonator 240 described above with reference to FIG. 2. The outer conductor 410 and the central conductor 430 may each have a cylindrical shape and may have the same axis. The resonator 240 may be formed by a cavity between the outer conductor 410 and the central conductor 430.

According to an example embodiment, the walls 421 and 422, the outer conductor 410, and the central conductor 430 may be metals. The waveguide 400 may be a coaxial type waveguide with a hollow therein. In addition, an insertion 250 may be formed to be connected to an inner space of the waveguide 400. The insertion 250 may be connected to the wall 422 in a manner of extending toward an internal cylindrical-shaped space formed by the central conductor 430. A material of the insertion 250 may be different from a material of the waveguide 400. For example, the material of the waveguide 400 may be a material for preventing an electromagnetic field generated in the cavity therein from being propagated outside, and the material of the insertion 250 may be a material that does not have an influence on propagation of the electromagnetic field.

The central conductor 430 may be connected to a first end by the first wall 421. The central conductor 430 may include an open end 431 that is not connected to other metals. The insertion 250 may be formed inside the waveguide 400 such that an aerosol-generating substrate 470 may be in the open end 431 and an end portion of the insertion 240.

The resonator 450 may be formed by the first end by the first wall 421 of the waveguide 400 and the central conductor 430. In other words, the resonator 450 may have a shape of a doughnut with the central conductor 430 as a center thereof.

According to an example embodiment, a first end of the resonator 450 may be formed as a short-circuited end in which an outer conductor (or a wall) and a central conductor are connected and a second end of the resonator 450 facing the first end may be formed as an open end in which the outer conductor (or the wall) and the central conductor are not connected and are spaced apart from each other, such that the resonator 450 may have a length corresponding to ¼ of a wavelength of a microwave in the resonator 450. A length between the first end and the second end may be an integer multiple of ¼ of the wavelength. If a microwave is confined in a limited space, such as the resonator 450, the microwave may have a wavelength different from that of a microwave radiated in a free space. In an example, the wavelength of the microwave may vary depending on a structural factor of the resonator 450. In another example, a wavelength of a microwave in a dielectric included in the resonator 450 may decrease as a dielectric constant value of the dielectric increases.

According to an example embodiment, a user may insert the aerosol-generating substrate 470 through the insertion 250 to be adjacent to the open end 431 of the central conductor 430 disposed opposite the first end by the first wall 421. The aerosol-generating substrate 470 may be a tobacco medium. For example, the aerosol-generating substrate 470 may include an aerosol former such as glycerin and propylene glycol.

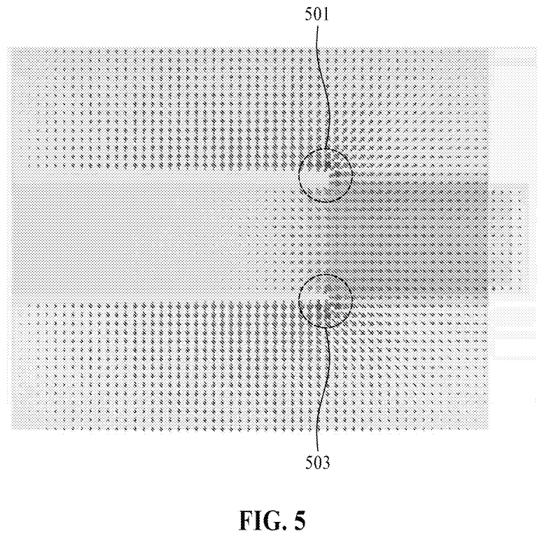

Microwaves may be supplied to a cavity of the waveguide 400 through the microwave coupler 230, and may be resonated by the resonator 450. An amplified electromagnetic field may be formed in the resonator 450 by the resonating microwave, and the aerosol-generating substrate 470 may be heated by at least a portion of the electromagnetic field. An electromagnetic field formed by microwaves will be described in detail with reference to FIG. 5 below.

At least a portion of the electromagnetic field may also act on the aerosol-generating substrate 470 through the open end 431 formed by disconnecting the central conductor 430 and the insertion 250. In particular, since a strong electromagnetic field is formed around the open end 431, the aerosol-generating substrate 470 may be easily heated. For example, on a side of the resonator 450, a strongest electromagnetic field may be generated in the open end 431 in which a resonance peak is formed. A portion of the formed electromagnetic field may leak into the aerosol-generating substrate 470 adjacent to the resonator 450, and may heat the aerosol-generating substrate 470. In other words, the above-described scheme of heating the aerosol-generating substrate 470 may be a scheme in which an electromagnetic field leaking to a space between the open end 431 and the insertion 250 heats an aerosol-generating substrate, instead of directly heating an aerosol-generating substrate included in a resonator.

In addition, due to a structure of the resonator 450, the electromagnetic field may be prevented from leaking toward the insertion 250 rather than a region of the resonator 450. In other words, the electromagnetic field leaking into the aerosol-generating substrate 470 may merely heat the aerosol-generating substrate 470, and may not propagate to the outside (e.g., in a direction of a user's mouth). Since the electromagnetic field does not propagate (or leak) to a space other than the regions of the resonator 450, a separate function or structure of the electronic device 100 for shielding an electromagnetic field is not required.

According to an example embodiment, a diameter of the insertion 250 may be less than ½ of the wavelength of the microwave. If the diameter of the insertion 250 is less than ½ of the wavelength of the microwave, a microwave that causes a resonance may be cut off.

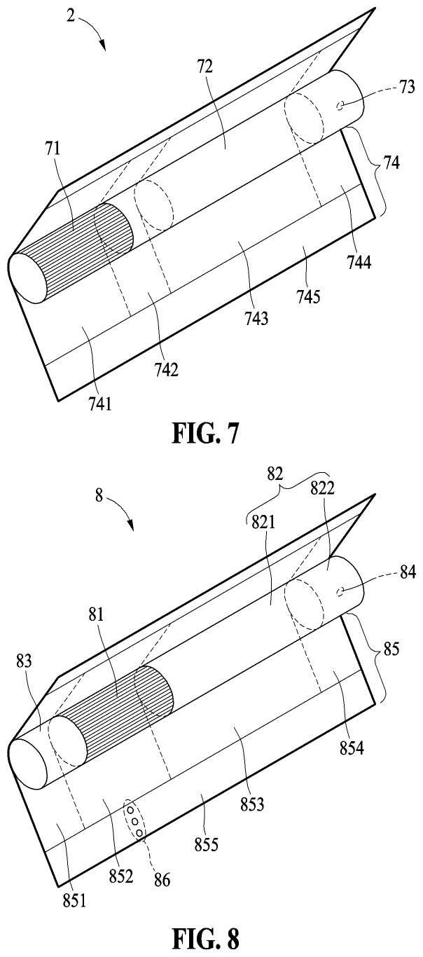

A user may inhale an aerosol generated by the heated aerosol-generating substrate 470, through the cigarette 2. A structure of the cigarette 2 will be described in detail with reference to FIGS. 7 and 8 below.

According to an example embodiment, a cavity of the resonator 450 may be filled with low-loss dielectrics (e.g., Teflon, quartz, alumina, etc.). If a cavity is filled with a dielectric having a low dielectric loss, the size of the resonator 450 may be further reduced.

FIG. 5 illustrates an electromagnetic field formed by microwaves according to an example embodiment.

An electromagnetic field formed by microwaves according to an example by the structure of the resonator 450 and the insertion 250 described with reference to FIG. 4 may be shown. The shown electromagnetic field is associated with a cross section of the above-described waveguide 400. A strongest electromagnetic field may be formed in regions 501 and 503. The regions 501 and 503 may correspond to the open end 431 of the central conductor 430 described above with reference to FIG. 4. Accordingly, an aerosol-generating substrate (e.g., the aerosol-generating substrate 470 of FIG. 4) adjacent to the regions 501 and 503 may be heated by a strong electromagnetic field leaking into the space between the open end 431 and the insertion 250. In addition, it is observed that the electromagnetic field does not leak in a direction of an insertion (e.g., the insertion 250 of FIG. 2) into which the aerosol-generating substrate is inserted.

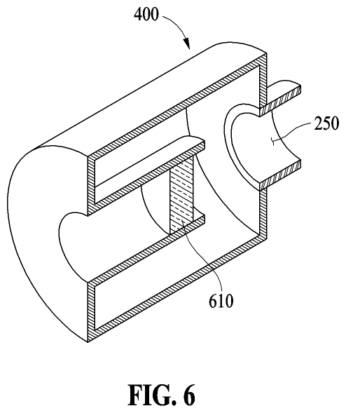

FIG. 6 illustrates a sensor according to an example embodiment.

According to an example embodiment, at least one sensor 610 may be further included in the waveguide 400 described above with reference to FIG. 4. The sensor 610 may include, for example, at least one of a puff detection sensor, a temperature detection sensor, or a cigarette insertion detection sensor.

According to an example embodiment, the sensor 610 may be located in a central portion of the waveguide 400. For example, when the aerosol-generating substrate 470 of the cigarette (e.g., the cigarette 2 of FIG. 1) is disposed in the waveguide 400 through the insertion 250, a tip portion of the cigarette may be adjacent to the sensor 610. The sensor 610 may detect an insertion of a cigarette. Alternatively, the sensor 610 may measure a temperature of the aerosol-generating substrate 470.

FIGS. 7 and 8 illustrate examples of a structure of a cigarette according to an example embodiment.

Referring to FIG. 7, the cigarette 2 may include a tobacco rod 71 and a filter rod 72. The filter rod 72 is illustrated as having a single segment in FIG. 7. However, example embodiments are not limited thereto. That is, the filter rod 72 may also include a plurality of segments. For example, the filter rod 72 may include a segment that cools an aerosol and a segment that filters a predetermined ingredient contained in an aerosol. In addition, as needed, the filter rod 72 may further include at least one segment that performs other functions.

The cigarette 2 may be wrapped with at least one wrapper 74. The wrapper 74 may have at least one hole through which external air is introduced or internal gas is discharged. In an example, the cigarette 2 may be wrapped with one wrapper 74. In another example, the cigarette 2 may be wrapped with two or more wrappers 74 in an overlapping manner. For example, the tobacco rod 71 may be wrapped with a first wrapper 741, and the filter rod 72 may be wrapped with wrappers 742, 743, and 744. In addition, the cigarette 2 may be entirely wrapped again with a single wrapper 745. If the filter rod 72 includes a plurality of segments, the segments may be wrapped with the wrappers 742, 743, and 744, respectively.

The tobacco rod 71 may include an aerosol-generating substrate (e.g., the aerosol-generating substrate 470). The aerosol-generating substrate may include, for example, at least one of glycerin, propylene glycol, ethylene glycol, dipropylene glycol, diethylene glycol, triethylene glycol, tetraethylene glycol, or oleyl alcohol, but is not limited thereto. The tobacco rod 71 may also include other additives such as a flavoring agent, a wetting agent, and/or an organic acid. In addition, the tobacco rod 71 may include a flavoring liquid such as menthol or a moisturizing agent that is added as being sprayed onto the tobacco rod 71.

The tobacco rod 71 may be fabricated in various forms. For example, the tobacco rod 71 may be fabricated as a sheet or as a strand. The tobacco rod 71 may also be formed of tobacco leaves finely cut from a tobacco sheet.

In addition, the tobacco rod 71 may be surrounded by a thermally conductive material. The thermally conductive material may be, for example, a metal foil such as an aluminum foil, but is not limited thereto. For example, the thermally conductive material surrounding the tobacco rod 71 may evenly distribute heat transferred to the tobacco rod 71, to increase the conductivity of heat to be applied to the tobacco rod 71, thereby improving taste of tobacco. In addition, the thermally conductive material surrounding the tobacco rod 71 may function as a susceptor heated by an induction heater. Here, although not shown in the drawings, the tobacco rod 71 may further include an additional susceptor in addition to the thermally conductive material surrounding the outside thereof.

The filter rod 72 may be a cellulose acetate filter. However, a shape of the filter rod 72 is not limited. For example, the filter rod 72 may be a cylindrical rod, or a tubular rod including a hollow therein. The filter rod 72 may also be a recess-type rod. For example, when the filter rod 72 includes a plurality of segments, at least one of the segments may be manufactured in a different shape.

In addition, the filter rod 72 may include at least one capsule 73. The capsule 73 may perform a function of generating a flavor or a function of generating an aerosol. For example, the capsule 73 may have a structure in which a liquid containing a flavoring material is wrapped with a film. The capsule 73 may have a spherical or cylindrical shape. However, example embodiments are not limited thereto.

Referring to FIG. 8, a cigarette 8 may further include a front end plug 83, in comparison to the cigarette 2. The front end plug 83 may be disposed on one side of the tobacco rod 81 facing the filter rod 82. The front end plug 83 may prevent the tobacco rod 81 from escaping to the outside, and may prevent an aerosol generated from the tobacco rod 81 during smoking from flowing into the electronic device 100.

The filter rod 82 may include a first segment 821 and a second segment 822. Here, the first segment 821 may correspond to a first segment of the filter rod 72 of FIG. 7, and the second segment 822 may correspond to a third segment of the filter rod 72 of FIG. 7.

A diameter and a total length of the cigarette 8 may correspond to a diameter and a total length of the cigarette 2. For example, a length of the front end plug 83 may be about 7 mm, a length of the tobacco rod 81 may be about 15 mm, a length of the first segment 821 may be about 12 mm, and a length of the second segment 822 may be about 14 mm. However, example embodiments are not limited thereto.

The cigarette 8 may be wrapped by at least one wrapper 85. The wrapper 85 may have at least one hole through which external air is introduced or internal gas is discharged. For example, the front end plug 83 may be wrapped with a first wrapper 851, the tobacco rod 81 may be wrapped with a second wrapper 852, the first segment 821 may be wrapped with a third wrapper 853, and the second segment 822 may be wrapped with a fourth wrapper 854. In addition, the cigarette 8 may be entirely wrapped again with a fifth wrapper 855.

In addition, at least one perforation 86 may be formed in the fifth wrapper 855. For example, the perforation 86 may be formed in a region surrounding the tobacco rod 81, however, example embodiments are not limited thereto. The perforation 86 may perform a function of transferring heat generated on an outer surface by an electromagnetic field to the inside of the tobacco rod 81.

Also, the second segment 822 may include at least one capsule 84. The capsule 84 may perform a function of generating a flavor or a function of generating an aerosol. For example, the capsule 84 may have a structure in which a liquid containing a flavoring material is wrapped with a film. The capsule 84 may have a spherical or cylindrical shape. However, example embodiments are not limited thereto.

FIG. 9 is a flowchart of a method of generating an aerosol according to an example embodiment.

Operations 910 through 940 that will be described below may be performed by the electronic device 100 described above with reference to FIGS. 1 through 6.

In operation 910, the electronic device 100 may generate a microwave of a preset frequency using the signal source 222 of the generator 220. The preset frequency may be in a 915 MHz band, a 2.45 GHz band, or a 5.8 GHz band allowed for heating. However, example embodiments are not limited thereto.

In operation 915, the electronic device 100 may adjust an amplitude (or an output) of the microwave using the amplifier 225 of the generator 220. By adjusting the amplitude of the microwave, a heating temperature may be adjusted.

In operation 920, the electronic device 100 may supply the microwave to the resonator 240 formed based on a waveguide through the microwave coupler 230.

In operation 930, the electronic device 100 may generate an electromagnetic field by resonating the microwave using the resonator 240. The waveguide may be a coaxial type waveguide with a hollow therein. For example, a pattern of a microwave may be formed in a TEM mode by a structure of the resonator 240 so that the microwave may resonate.

Since the pattern of the microwave is formed in the TEM mode by a structure of an outer conductor and a central conductor of the waveguide, a cavity having a size smaller than ⅕ of the wavelength of the microwave may be available.

According to an example embodiment, the resonator 240 may include a resonator (e.g., the resonator 450 of FIG. 4) having a shape of a doughnut with an empty space. A resonator may be a quarter wavelength resonator in which one side is closed and the other side is opened.

In operation 940, the electronic device 100 may generate an aerosol when an aerosol-generating substrate (e.g., the aerosol-generating substrate 470 of FIG. 4) inserted into a waveguide (e.g., the waveguide 400) is heated as an electromagnetic field formed by the resonating microwave leaks into the space between the open end 431 of the resonator and the insertion 250. A user may inhale the generated aerosol through the filter rod 72, 82 of the cigarette 2, 8.

FIG. 10 is a flowchart of a method of controlling a generation of a microwave based on a temperature of an aerosol-generating substrate according to an example embodiment.

According to an example embodiment, operations 1010 and 1020 may be further performed after operation 940 described above with reference to FIG. 9 is performed.

In operation 1010, the electronic device 100 may measure the temperature of the aerosol-generating substrate. For example, the electronic device 100 may measure the temperature of the aerosol-generating substrate using the sensor 610 described above with reference to FIG. 6.

In operation 1020, the electronic device 100 may stop the generating of the microwave when the measured temperature is greater than or equal to a preset first threshold temperature. By stopping the generation of the microwave, it may be possible to prevent the aerosol-generating substrate from being excessively heated.

According to an example embodiment, when the measured temperature is greater than or equal to the preset first threshold temperature, the electronic device 100 may adjust an amplitude (or an output) of the microwave. By reducing the amplitude of the microwave, it may be possible to prevent the aerosol-generating substrate from being excessively heated. Operation 910 described above with reference to FIG. 9 may further include operation 1030 that will be described below.

In operation 1030, the electronic device 100 may generate a microwave when the temperature of the aerosol-generating substrate is less than a second threshold temperature.

According to an example embodiment, when the measured temperature is less than a preset second threshold temperature, the electronic device 100 may adjust the amplitude (or the output) of the microwave. By increasing the amplitude of the microwave, the aerosol-generating substrate may be heated with a strong energy.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape:

optical media such as CD-ROM discs or DVDs: magneto-optical media such as optical discs; and hardware devices that are specially configured to store and perform program instructions, such as read-only memory (ROM), RAM, flash memory, and the like. Examples of program instructions include both machine code, such as produced by a compiler, and higher-level code that may be executed by the computer using an interpreter. The above-described devices may be configured to act as one or more software modules in order to perform the operations of the above-described example embodiments, or vice versa.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

While this disclosure includes example embodiments, it will be apparent to one of ordinary skill in the art that various changes in form and details may be made in these example embodiments without departing from the spirit and scope of the claims and their equivalents. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. An electronic device comprising:
a controller configured to control an operation of the electronic device;
a generator configured to generate a microwave of a preset frequency;
a microwave coupler configured to supply the generated microwave to a resonator;
the resonator configured to generate an amplified electromagnetic field by resonating the microwave; and
an insertion into which an aerosol-generating substrate is inserted such that the aerosol-generating substrate is adjacent to the resonator,
wherein an aerosol is generated when at least a portion of the electromagnetic field heats the aerosol-generating substrate.

2. The electronic device of claim 1, wherein the resonator is formed by a cavity between an outer conductor and a central conductor which each have a cylindrical shape.

3. The electronic device of claim 1, wherein
the outer conductor and the central conductor have a same axis, and
the insertion is formed based on an inner region of the central conductor.

4. The electronic device of claim 1, wherein
a length of the resonator is ¼ of a wavelength of the microwave in the resonator, and
a first end of the resonator is formed as a short-circuited end in which the outer conductor and the central conductor are connected, and a second end of the resonator facing the first end is formed as an open end in which the outer conductor and the central conductor are not connected and are spaced apart from each other.

5. The electronic device of claim 2, wherein
the outer conductor and the central conductor form a waveguide,
the central conductor is connected to a first end of the waveguide, and
the aerosol-generating substrate is inserted through the insertion to be adjacent to an open end of the central conductor disposed opposite the first end.

6. The electronic device of claim 5, wherein the resonator is formed by the first end of the waveguide and the central conductor.

7. A method of generating an aerosol, the method being performed by an electronic device and comprising:
generating a microwave of a preset frequency using a generator;
supplying the generated microwave to a resonator through a microwave coupler, the resonator being formed by a cavity between an outer conductor and a central conductor which each have a cylindrical shape;
generating an amplified electromagnetic field by resonating the microwave using the resonator; and
generating an aerosol when at least a portion of the electromagnetic field heats an aerosol-generating substrate inserted to be adjacent to the central conductor.

8. The method of claim 7, wherein the outer conductor and the central conductor have a same axis.

9. The method of claim 7, wherein the generating of the amplified electromagnetic field by resonating the microwave using the resonator comprises resonating the microwave by forming a pattern of the microwave in a transvers electromagnetic (TEM) electromagnetic (TEM) mode by a structure of the outer conductor and the central conductor.

10. The method of claim 7, wherein
a length of the resonator is ¼ of a wavelength of the microwave in the resonator, and
a first end of the resonator is formed as a short-circuited end in which the outer conductor and the central conductor are connected, and a second end of the resonator facing the first end is formed as an open end in which the outer conductor and the central conductor are not connected and are spaced apart from each other.

11. The method of claim 10, wherein a length between the first end and the second end is an integer multiple of ¼ of the wavelength.

12. The method of claim 7, wherein
the outer conductor and the central conductor form a waveguide,
the central conductor is connected to a first end of the waveguide, and
the aerosol-generating substrate is inserted to be adjacent to an open end of the central conductor disposed opposite the first end.

13. The method of claim 12, wherein the resonator is formed by the first end of the waveguide and the central conductor.

14. The method of claim 7, wherein a diameter of an insertion connected to an inner space of the central conductor is less than ½ of a wavelength of the microwave.

15. The method of claim 7, wherein a dielectric is included in the cavity.

16. The method of claim 7, further comprising:
measuring a temperature of the aerosol-generating substrate; and
stopping the generating of the microwave when the measured temperature is greater than or equal to a preset first threshold temperature.

17. The method of claim 16, wherein the generating of the microwave of the preset frequency using the generator comprises generating the microwave when the temperature of the aerosol-generating substrate measured in a state in which the generating of the microwave is stopped is less than a preset second threshold temperature.

18. A non-transitory computer-readable storage medium storing a program for executing the method of claim 7.
